(19) United States
(12) Patent Application Publication
(10) Pub. No.: US 2023/0104094 A1
(43) Pub. Date: Apr. 6, 2023

(54) A METHOD FOR PROCESSING LITHIUM IRON PHOSPHATE BATTERIES

(71) Applicant: Li-Cycle Corp., Mississauga (CA)

(72) Inventors: Timothy George Johnston, Toronto (CA); Darcy Lionel Tait, Uxbridge (CA); Christopher James Biederman, Hannon (CA)

(73) Assignee: Li-Cycle Corp., Mississauga, ON (CA)

(21) Appl. No.: 17/908,637

(22) PCT Filed: Mar. 2, 2021
(86) PCT No.: PCT/CA2021/050266

§ 371 Date: Sep. 1, 2022

Related U.S. Application Data
(60) Provisional application No. 62/983,830, filed on Mar. 2, 2020.

(51) Int. Cl. C22B 7/00; C22B 3/46; C22B 26/12; C22B 15/00; C22B 3/08; H01M 10/54

(52) U.S. Cl. CPC C22B 7/007; C22B 3/46; C22B 26/12; C22B 15/0065; C22B 3/08; H01M 10/54

(57) ABSTRACT

A method of processing a black mass material feed material can include a) receiving a black mass material feed material; b) acid leaching the black mass material at a pH that is less than 4, thereby producing a pregnant leach solution (PLS) comprising at least 80% the lithium from the black mass feed material, and at least a portion of the iron and the phosphorous from the black mass feed material; providing a first intermediary solution after completing step b); and separating at least 90% of the iron and the phosphorous from the first intermediary solution to provide an output solution.

### CROSS-REFERENCE TO PRIOR APPLICATION

This application claims the benefit of U.S. provisional patent application No. 62/983,830, filed Mar. 2, 2020 and entitled A Method For Processing Used Lithium Iron Phosphate Batteries, the entirety of which is incorporated herein by reference.

### FIELD OF THE INVENTION

In one of its aspects, the present disclosure relates generally to a method for processing lithium iron phosphate (LFP) batteries, and more particularly to the recycling of LFP batteries and the recovery of at least some lithium therefrom.

### INTRODUCTION

U.S. Pat. No. 9,312,581 relates to a method for recycling lithium batteries and more particularly batteries of the Li-ion type and the electrodes of such batteries. This method for recycling lithium battery electrodes and/or lithium batteries comprises the following steps: a) grinding of said electrodes and/or of said batteries, b) dissolving the organic and/or polymeric components of said electrodes and/or of said batteries in an organic solvent, c) separating the undissolved metals present in the suspension obtained in step b), d) filtering the suspension obtained in step c) through a filter press, e) recovering the solid mass retained on the filter press in step d), and suspending this solid mass in water, f) recovering the material that sedimented or coagulated in step e), resuspending this sedimented material in water and adjusting the pH of the suspension obtained to a pH below 5, preferably below 4, g) filtering the suspension obtained in step f) on a filter press, and h) separating, on the one hand, the iron by precipitation of iron phosphates, and on the other hand the lithium by precipitation of a lithium salt. The method of the invention finds application in the field of recycling of used batteries, in particular.

International Patent Application No. WO2005/101564 a method for treating all types of lithium anode batteries and cells via a hydrometallurgical process at room temperature. Said method is used to treat, under safe conditions, cells and batteries including a metallic lithium anode or an anode containing lithium incorporated in an anode inclusion compound, whereby the metallic casings, the electrode contacts, the cathode metal oxides and the lithium salts can be separated and recovered.

US Patent Publication No. 2010/0230518 discloses a method of recycling sealed batteries, the batteries are shredded to form a shredded feedstock. The shredded feedstock is heated above ambient temperature and rolled to form a dried material. The dried material is screen separating into a coarse fraction and a powder fraction and the powder fraction is output. A system for recycling sealed cell batteries comprises an oven with a first conveyor extending into the oven. A rotatable tunnel extends within the oven from an output of the first conveyor. The tunnel has a spiral vane depending from its inner surface which extends along a length of the tunnel. A second conveyor is positioned below an output of the rotatable tunnel.

U.S. Pat. No. ______ discloses a valuable-substance recovery method according to the present invention includes: a solvent peeling step (S3) of dissolving a resin binder included in an electrode material by immersing crushed pieces of a lithium secondary battery into a solvent, so as to peel off the electrode material containing valuable substances from a metal foil constituting the electrode; a filtering step (S4) of filtering a suspension of the solvent, so as to separate and recover the electrode material containing the valuable substances and a carbon material; a heat treatment step (S5) of heating the recovered electrode material containing the valuable substances and the carbon material, under an oxidative atmosphere, so as to burn and remove the carbon material; and a reducing reaction step (S6) of immersing the resultant electrode material containing the valuable substances into a molten salt of lithium chloride containing metal lithium, so as to perform a reducing reaction.

### SUMMARY

Lithium-ion rechargeable batteries are increasingly powering automotive, consumer electronic, and industrial energy storage applications. However, approximately less than 5% of produced spent lithium-ion batteries are recycled globally, equivalent to approximately 70,000 tonnes of spent lithium-ion batteries recycled/year. In contrast, an estimated 11+ million tonnes of spent lithium-ion battery packs are expected to be discarded between 2017 and 2030, driven by application of lithium-ion batteries in electro-mobility applications such as electric vehicles.

Rechargeable lithium-ion batteries comprise a number of different materials. Large format lithium-ion battery packs (e.g. in automotive and stationary energy storage system applications) are generally structured as follows: a. Cells: cells contain the cathode, anode, electrolyte, separator, housed in steel, aluminum, and/or plastic; b. Modules: multiple cells make up a module, typically housed in steel, aluminum, and/or plastic; and c. Battery pack: multiple modules make up a battery pack, typically housed in steel, aluminum, and/or plastic.

Of these components, it is estimated that approximately seven comprise >90% of the residual value in a spent lithium-ion battery: cobalt, lithium, copper, graphite, nickel, aluminum, and manganese. For example, an estimated weighted-average composition of mixed format lithium-ion battery packs based on residual values of contained materials in a spent lithium-ion battery (USD per kg material/kg lithium-ion battery pack) comprises approximately: 9% Ni, 2% Mn, 39% Co, 16% Li₂CO₃ (expressed as lithium carbonate equivalent) 12% Cu, 5% Al, 10% graphite, and 7% other materials.

A portion of the lithium-ion batteries can be described as lithium iron phosphate (LFP, or sometimes as a lithium ferrophosphate battery) batteries and these batteries may have a different composition than other types of lithium-ion batteries. For example, LFP batteries utilize LiFePO₄ as a cathode material, usually in combination with a graphitic carbon-based anode. LFP batteries typically include relatively lower amounts of metals, such as nickel and cobalt, than other types of lithium-ion batteries, and many LFP batteries do not contain any of these metals (such as nickel and cobalt). As nickel and cobalt can be relatively valuable, the relatively low amounts and/or absence of these metals in LFP batteries may make LFP batteries less desirable to recycle than other forms of batteries that would yield relatively larger amounts of these valuable metals.

However, the inventors have now developed a process for recycling LFP batteries that can be used to help extract the lithium from such batteries in a manner that may be suitable for commercial recycling operations. In some embodiments the process may also produce ferrous phosphate, via filtering the output material exiting the iron and phosphorous precipitation process, as an output in a form that can be suitable for incorporation into fertilizers and/or may have other industrial or agricultural uses.

“Black mass” as used herein refers to a component of rechargeable lithium-ion batteries, which includes at least a combination of cathode and/or anode electrode powders comprising lithium metal oxides and lithium iron phosphate (cathode) and graphite (anode). Materials present in rechargeable lithium-ion batteries include organics such as alkyl carbonates (e.g. Ci-C6 alkyl carbonates, such as ethylene carbonate (EC), ethyl methyl carbonate (EMC), dimethyl carbonate (DMC), diethyl carbonate (DEC), propylene carbonate (PC), and mixtures thereof), iron, aluminum, copper, plastics, graphite, cobalt, nickel, manganese, and of course lithium. If the batteries are LFP batteries, then metals included in the black mass may be expected to include a majority of phosphorous and iron (by weight) along with lithium. Recovering the lithium from black mass that is liberated from within LFP batteries is desirable.

In accordance with one broad aspect of the teachings described herein, a method of processing black mass material obtained from lithium iron phosphate (LFP) batteries includes the steps of
a) receiving an input material containing black mass material comprising iron, phosphate and lithium derived from LFP batteries;
b) adjusting a pH of the input material to be between about 8 and 11
c) adjusting a concentration of Fe₂SO₄ within the input material so that the input material has a molar ratio of about 1.5-3.5 mol Fe₂SO₄ to about 0.5 to 1.5 mol P₂SO₄.
d) re-adjusting a pH of the input material to be between about 8 and 11 after adjusting the concentration of Fe₂SO₄; and
e) separating ferrous phosphate from the input material thereby producing a first intermediary solution comprising less ferrous phosphate (wt %) than the input material and having a first concentration of Li₂SO₄.

The method may include processing the first intermediary solution to produce a second intermediary material having a second concentration of Li₂SO₄ that is greater than the first concentration of Li₂SO₄.

The method may include the step of processing the second intermediary material to separate at least one lithium compound from the second intermediary material.

The at least one lithium compound may include at least one of lithium carbonate and lithium hydroxide.

The method may include introducing a flocculant into the input material and precipitating ferrous phosphate out of solution.

The flocculant may include C—(N—COCO-1, 3 diaminopropane acetate)

The flocculant may have a concentration of between about 10 ppm and about 30 ppm, and preferably has a concentration of about 20 ppm.

The method may include filtering the input material to remove solids that may contain one or more of iron, phosphate, and calcium or sodium.

The input material may include a flowable slurry including the black mass material and an organic solvent and processing the first intermediary solution to produce a second intermediary material may include evaporating at least a portion of the organic solvent from the first intermediary solution.

This processing may include boiling the first intermediary solution.

Prior to step of receiving an input material containing black mass material the method may include preparing the input material via the steps:
a) processing LFP batteries to form a size-reduced feed stream;
b) separating the size-reduced feed stream into a magnetic product stream and a first non-magnetic feed stream;
c) optionally isolating a ferrous product from the magnetic product stream;
d) separating the first non-magnetic feed stream into an aluminum product stream and a second non-magnetic feed stream;
e) optionally isolating an aluminum product from the aluminum product stream;
f) leaching the second non-magnetic feed stream with acid to form a leached slurry; and
g) separating the leached slurry into a first product stream (that can be processed to extract copper products) and a second product stream that comprises the black mass material.

In accordance with another broad aspect of the teachings described herein, which may be used in combination with any other aspects a method of processing a black mass material feed material comprising materials liberated from within lithium iron phosphate (LFP) batteries may include the steps of:

a) receiving a black mass material feed material comprising iron, phosphorous, graphite and lithium derived from LFP batteries and having a first concentration of lithium;

b) acid leaching the black mass material at a pH that is less than 4, thereby producing a pregnant leach solution (PLS) comprising less graphite than the black mass feed material, at least 80% the lithium from the black mass feed material, and at least a portion of the iron and the phosphorous from the black mass feed material, the PLS having a second concentration of lithium that is greater than the first concentration of lithium;

c) providing a first intermediary solution after completing step b); and

d) separating at least 90% of the iron and the phosphorous from the first intermediary solution to provide an output solution having less iron and phosphate than the first intermediary solution and having a third concentration of lithium that is greater than the second concentration.

The first intermediary solution may include the PLS.

The PLS may include copper and the method may also include processing the PLS to remove substantially all of the copper and produce a copper-depleted PLS, whereby the first intermediary solution comprises the copper-depleted PLS.

Processing the PLS to remove substantially all of the copper may include at least one of a copper solvent extraction process, a copper cementing process and a copper sulphide precipitation process

Processing the PLS to remove substantially all of the copper may include sulfide precipitation of the PLS whereby copper sulphide is precipitated from the PLS to produce the copper-depleted PLS.

The sulfide precipitation of the PLS may include adding a reductant comprising at least one of sodium hydrosulphide and sodium sulphide to the PLS.

The sulfide precipitation may be conducted with a residence time of between about 0.5 and about 4 hours and at an operating temperature that is between approximately 5 and 80 degrees Celsius.

The residence time may be about 2 hours and the operating temperature may be about 20 degrees Celsius.

The sulfide precipitation may be conducted with a solution pH that is less than 4.

The solution pH may be about 1.5.

The sulfide precipitation may produce a filtrate solution having an oxidation reduction potential (ORP) between −200 mV and 0 mV.

The method may include adjusting the ORP of the filtrate solution to be equal to or above 400 mV by introducing an oxidant into the filtrate solution, thereby producing the copper-depleted PLS.

At least 99% of the copper may be precipitated out of the PLS.

The separating in step 1d) may include precipitating at least the iron and the phosphorous from the first intermediary solution via hydroxide precipitation, thereby producing the output solution.

The method may include adjusting a pH of the first intermediary solution to be between about 8 and 11 to promote the precipitation of the iron and the phosphorous.

The method may include adjusting the pH to be between 10 and 10.5.

Adjusting the pH may include introducing at least one of calcium hydroxide and sodium hydroxide as a precipitating reagent during the hydroxide precipitation.

Adjusting the pH may include adding Ca(OH)₂ to the first intermediary solution.

Adjusting the pH may include adding sodium hydroxide to the first intermediary solution.

The method may include adjusting the first intermediary solution so that a mol ratio of iron to phosphorous (Fe:P) in the first intermediary solution is between about 1 and about 4.

The mol ratio of iron to phosphorous (Fe:P) in the first intermediary solution may be about 2.

The mol ratio of iron to phosphorous (Fe:P) in the first intermediary solution may be adjusted by adding an iron-containing reagent into the first intermediary solution.

The may include introducing a flocculant into the first intermediary solution.

The flocculant may include C—(N—COCO-1, 3 diaminopropane acetate).

The flocculant may have a concentration of between about 10 ppm and about 30 ppm in the first intermediary solution.

The method may include filtering the first intermediary solution to remove solid ferrous phosphate particle and produce the output solution.

The method may include pre-conditioning the black mass material prior to step 1b) by adding a solvent to the black mass material to provide a flowable black mass slurry.

The flowable black mass slurry may have a pulp density of between about 15 wt % and about 35 wt %.

The acid leaching may be conducted at a temperature that is between 20 and 100 degrees Celsius.

Wherein the acid leaching the black mass material may include leaching the black mass material using a leaching solution comprising sulfuric acid, whereby the PLS may include lithium, phosphate, iron and sulfate.

The acid leaching may include leaching the black mass using a leaching solution having a pH of between about 0.5 and about 2.0.

The leaching solution may include an initial free acid concentration of between about 30 g/L and about 60 g/L.

The acid leaching may include conducted for a residence time that is between about 2 hours and about 6 hours.

The concentration of lithium in the PLS may be greater than the concentrations of phosphate, and iron in the PLS.

The acid leaching may be conducted for a leaching residence time that is between about 2 hours and about 6 hours. The leaching solution may be at a leaching temperature that is between about 15 degrees Celsius and about 80 degrees Celsius.

The method may include concentrating the output solution by extracting at least some solvent from the output solution to produce a concentrated output solution having a fourth concentration of lithium (wt %) that is greater than the third concentration of lithium.

The black mass material may include at least 1.5%/wt lithium.

The black mass material may include less than about 10% wt lithium.

The black mass material may include about 3% wt lithium.

The black mass material may include at least 10%/wt iron.

The black mass material may include less than 70% wt iron, and

The black mass material may include about 18% wt iron.

The black mass material may include at least 5%/wt phosphorous.

The black mass material may include less than about 40% wt phosphorous.

The black mass material may include less than about 10% wt phosphorous.

The output solution may include calcium and the method may include extracting substantially all of the calcium from the output solution to provide a calcium-depleted material stream including at least lithium and sodium.

Extracting substantially all of the calcium from the output solution may include a carbonate precipitation process via which more than 95% of the calcium is precipitated out of the output solution.

The method may include adding a sodium carbonate precipitating agent at a ratio of about 1.25× the stoichiometric concentration of calcium in the output solution.

The carbonate precipitation process may be conducted at a pH that is less than 11, for a residence time that is between 0.5 and 4 hours and at a temperature that is between about 5 and about 80 degrees Celsius.

The method may include extracting substantially all of the lithium from the calcium-depleted material stream to provide lithium-rich residue and a lithium-depleted stream comprising the sodium.

Extracting substantially all of the lithium from the calcium-depleted material stream may utilize a carbonate precipitation process in which a Na₂CO₃ solution was added to the calcium-depleted material stream at a ratio of 1.25 times the stoichiometric requirement to precipitate the lithium, whereby more than 80% of the lithium is precipitated out of the calcium-depleted material stream as the lithium-rich residue.

Other advantages of the invention will become apparent to those of skill in the art upon reviewing the present specification.

### BRIEF DESCRIPTION OF THE DRAWINGS

Embodiments of the present invention will be described with reference to the accompanying drawings, wherein like reference numerals denote like parts, and in which:

FIG. 1 is one example of a method of processing black mass material obtained from lithium ion phosphate (LFP) batteries;

FIG. 2 is one example of a method of leaching a black mass material stream;

FIG. 3 is another example of a method of leaching a black mass material stream;

FIG. 4 is an example of a method of separating iron and phosphorous from a pregnant leach solution;

FIG. 5 is an example of a method of pre-thickening a pregnant leach solution; and

FIG. 6 is another example of a method of separating iron and phosphorous from a pregnant leach solution;

FIG. 7 is one example of portions of a treatment process that are downstream from the iron and phosphorous removal step; and

FIG. 8 is another example of a method of processing black mass material obtained from lithium ion phosphate (LFP) batteries.

### DETAILED DESCRIPTION

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors, or owners do not intend to abandon, disclaim, or dedicate to the public any such invention by its disclosure in this document.

Lithium-ion batteries are a type of rechargeable battery in which lithium ions drive an electrochemical reaction. Lithium has a high electrochemical potential and a high energy density. Lithium-ion battery cells have four key components: a. Positive electrode/cathode: including differing formulations of metal oxides or metal phosphate depending on battery application and manufacturer, intercalated on a cathode backing foil/current collector (e.g. aluminum)—for example: LiNixMnyCOzO2 (NMC); LiCoO2(LCO); LiFePO4 (LFP); LiMn2O4 (LMO); LiNiCoAlO2 (NCA); b. Negative electrode/anode: generally, comprises graphite intercalated on an anode backing foil/current collector (e.g. copper); c. Electrolyte: for example, lithium hexafluorophosphate (LiPF6), lithium tetrafluoroborate (LiBF4), lithium perchlorate (LiClO4), lithium hexafluoroarsenate monohydrate (LiAsF6), lithium trifluoromethanesulfonate (LiCF3SO3), lithium bis(bistrifluoromethanesulphonyl) (LiC₂F₆NO₄S₂), lithium organoborates, or lithium fluoroalkylphosphates dissolved in an organic solvent (e.g., mixtures of alkyl carbonates, e.g. Ci-C6 alkyl carbonates such as ethylene carbonate (EC, generally required as part of the mixture for sufficient negative electrode/anode passivation), ethyl methyl carbonate (EMC), dimethyl carbonate (DMC), diethyl carbonate (DEC), propylene carbonate (PC)); and d. Separator between the cathode and anode: for example, polymer or ceramic based.

A portion of the lithium-ion batteries can be described as lithium iron phosphate (LFP, or sometimes as a lithium ferrophosphate battery) batteries and these batteries may have a different composition than other types of lithium-ion batteries. For example, LFP batteries utilize LiFePO₄ as a cathode material, usually in combination with a graphitic carbon-based anode. LFP batteries typically include relatively lower amounts of metals, such as nickel and cobalt, than other types of lithium-ion batteries. As nickel and cobalt can be relatively valuable, the relatively low amounts of these metals in LFP batteries may make LFP batteries less desirable to recycle than other forms of batteries that would yield relatively larger amounts of these valuable metals.

As noted above, “black mass”, as used herein refers a combination of cathode and/or anode electrode powders from lithium ion batteries. The chemical composition of black mass various based on the battery type and composition being processes. Lithium iron phosphate (cathode) and graphite (anode) powders are expected to be the primarily components of black mass when processing primarily LFP batteries. Other materials will also be present in LFP black mass, including, residual organic electrolyte (e.g. Ci-C6 alkyl carbonates, such as ethylene carbonate (EC), ethyl methyl carbonate (EMC), dimethyl carbonate (DMC), diethyl carbonate (DEC), propylene carbonate (PC), and mixtures thereof), iron, aluminum, copper, and plastics.

The systems and processes for obtaining the black mass from LFP batteries can generally include one or more suitable, mechanical disassembly operations in which incoming LFP batteries in the form of whole batteries, cells and/or portions thereof, along with any associated leads, housings, wires and the like (collectively referred to as battery materials) are at least physically processed to liberate the black mass materials within the LFP battery cell for further processing. This can include physically shredding and/or grinding the incoming battery materials, such as using a suitable comminuting apparatus, in an operation that can break open the battery cells and can convert the incoming battery materials into a plurality of relatively small, size-reduced battery materials that can be further processed.

For example, the processes described herein may include, prior to step 102, the use of a physical disassembly apparatus or comminuting apparatus that can help to cause a size reduction of the battery materials to form reduced-size battery materials and to liberate electrolyte materials and a black mass material comprising anode and cathode powders from within the battery materials (such as LFP battery materials).

One example of a suitable apparatus that can be used may include a housing that has at least one battery inlet through which battery materials can be introduced into the housing. At least a first comminuting device can be disposed within the housing and is preferably configured to cause a size reduction of the battery materials to form reduced-size battery materials and to help liberate lithium metal and cathode materials from within the battery materials. The immersion material, such as an immersion liquid, may be provided within the housing and preferably is configured to submerge at least the first comminuting device, and optionally may also cover at least some of the battery materials. The size reduction of the battery materials using this apparatus can thereby be conducted under the immersion material (and under immersion conditions) whereby sparking caused by the size reduction of the battery material may be suppressed and heat generated by the size reduction is absorbed by the immersion liquid. This may also cause the electrolyte materials, the black mass material and the reduced-size battery material to become at least partially entrained within the immersion liquid to form a blended material, sized-reduced feed stream at the outlet of the physical disassembly apparatus that includes a mixture of the lithium metal, the cathode materials, electrolyte and immersion material. For example, a feed outlet can be provided downstream from the comminuting apparatus through which the sized-reduced feed stream comprising the reduced-size battery material, the black mass material and the electrolyte materials entrained within the immersion liquid can exit the housing.

The apparatus may optionally include a first separator that is submerged by the immersion liquid and is disposed at the feed outlet to receive the sized-reduced feed stream. The first separator may be configured to separate the sized-reduced feed stream into at least: i) a black mass solid product stream comprising the black mass material and a retained portion of the immersion liquid having entrained electrolyte materials; and ii) a first filtrate stream comprising a second portion of the immersion liquid having entrained electrolyte materials.

The retained portion of the immersion liquid may have entrained electrolyte that makes up to 20% wt of the black mass solid product stream.

The first separator may include a liquid-solid filter, whereby when the first filtrate stream passes through the liquid-solid filter and the black mass solid product stream is collected as a filter cake material retained by the liquid-solid filter.

The first separator may also optionally include a screen in fluid communication between the feed outlet and the liquid-solid filter. The screen may be configured to separate oversized solids from the sized-reduced feed stream before it reaches the liquid-solid separator while allowing the black mass material and the immersion liquid having entrained electrolyte materials to pass through the screen. The screen may be configured to retain solids having a size that is greater than about 2 mm.

The immersion liquid may be basic and is preferably at least electrically conductive.

The immersion liquid may be selected such that it reacts with hydrogen fluoride that may be produced via the liberation of the electrolyte materials during the size reduction process, whereby the evolution of hydrogen fluoride during the size reduction is inhibited. The immersion liquid within the housing may preferably be at an operating temperature that is less than 70 degrees Celsius to inhibit chemical reactions between the electrolyte materials and the immersion liquid, and optionally the operating temperature may be less than 60 degrees Celsius.

The immersion liquid may be at least one of water and an aqueous solution. The immersion liquid may have a pH that is greater than or equal to 8, and optionally may include at least one of sodium hydroxide and calcium hydroxide. The immersion liquid may include a salt, whereby the immersion liquid is electrically conductive to help at least partially dissipate a residual electrical charge within the battery materials that is released during the size reduction. The salt may include at least one of sodium hydroxide and calcium hydroxide.

Dust particles that are liberated from the battery materials by the comminuting apparatus during the size reduction may be captured and entrained within the immersion liquid and may be inhibited from escaping the housing into the surrounding atmosphere. The first comminuting device may be configured as a shredder that is configured to cause size reduction of the battery materials by at least one of compression and shearing. The black mass material obtained using these processes, including at least some residual amounts of the immersion liquid and any electrolytes entrained therein can form the black mass feed materials as described herein.

The sized-reduced battery materials exiting the disassembly apparatus can then be further processed, if appropriate, using one or more suitable process steps and/or apparatuses (including washing, screening, filtering and the like) to separate the desired LFP black mass product material from the other materials (such as plastics and other packaging materials, at least a portion of the electrolyte and other such materials). The desired black mass materials can be obtained as one of the outputs/products from the separation apparatus. Some suitable methods and processes for liberating black mass materials are available via Li-Cycle Corps. (of Mississauga, Canada) and are described in international patent publication no. WO2018/218358 entitled A Process, Apparatus, And System For Recovering Materials From Batteries and U.S. provisional patent application No. 63/122,757 entitled System And Method For Processing Solid State Or Primary Lithium Batteries, each of which are incorporated herein by reference.

The inventors have developed a process to extract at least a commercially relevant portion of the lithium from the black mass material, obtained by the processes described herein or via other suitable processes, that includes at least some material that is obtained from LFP batteries in a manner that may be suitable for commercial recycling operations. In some embodiments the process may also produce ferrous phosphate as an output in a form that can be suitable for incorporation into fertilizers and/or may have other industrial or agricultural uses.

In accordance with one broad aspect of the teachings described herein, a process that can be used to recover lithium from black mass is described. The processes described herein can be used to process a black mass material that includes a majority (by weight) of material that has been recovered from the electrodes of LFP batteries and optionally may be used to process a black mass input material that is derived entirely and/or substantially entirely from the recycling of LFP batteries. Preferably, the black mass materials used as inputs to the processes described herein may be selected such that the metal content within the black mass includes between about 20 and 45% wt phosphorous, between about 40 and 75% wt iron and between about 5% and 12% wt lithium. If formed from generally commercially available LFP batteries, the black mass described herein may be expected to include between 30-35% wt and possibly about 33% wt phosphorous, between 55-65% wt and possibly about 60% wt iron, and between 6-8% wt and possibly about 7% wt lithium. The new methods for processing black mass of this nature may help facilitate the recovery of lithium from LFP batteries in a relatively more efficient and potentially commercially viable manner. This may allow streams of black mass material from LFP batteries to be processed separately from streams of black mass material obtained from other types of batteries, and this may be preferable in some instances as the processes that are described herein may not be the preferred processes for processing other black mass product streams having different compositions.

The processes described herein can generally include the steps of receiving a suitable input black mass material obtained as part of a suitable, upstream separation process. Black mass can be received as a filtered solid with residual moisture or a flowable slurry. Optionally, the black mass material may be treated or conditioned to help make it more suitable for the processes described herein. For example, if black mass is received as a filtered solid, it can be re-slurried to form a flowable slurry that has a desired pulp density, such as a pulp density between 15 and 35 wt %, using water or other suitable solvents. When black mass is received as a flowable slurry, water may be added to achieve a suitable and/or desired pulp density, such as between about 15 and about 35 wt %.

Once the input black mass material has been suitably conditioned, the incoming black mass material can then be treated and/or processed to produce a conditioned material that is relatively rich in lithium as compared to the incoming black mass, and also contains quantities of iron, phosphate and sulfate. The composition of this intermediary material may vary based on the type of treatment process that is used, even if processing the same incoming black mass material.

The treatment process may provide the conditioned material in any suitable form such as, for example a slurry and/or a solution. For example, the treatment process may include the steps of at least partially leaching the incoming black mass material to provide a pregnant leach solution (PLS) that is relatively rich in at least lithium amongst other minor components and/or solvents. For example, the black mass material may be leached using suitable reagents, such as a mixture of sulfuric acid and other reagents to generate the PLS. The treatment process is configured so that the intermediary material (e.g. the PLS) is relatively more suitable for further processing and the removal of phosphorous than the native pre-processed black mass would have been.

In some examples the conditioned material may then be selectively leached to provide a PLS that is relatively rich in lithium but may contain relatively smaller quantities of iron, phosphate and sulfate, amongst other minor components and/or solvents.

In other examples the conditioned material may be leached in manner that provides PLS that is relatively rich in not only lithium, but may also have relatively high amounts of iron, phosphate and sulfate, amongst other minor components and/or solvents. It is believed that the molar ratio of these metals in a common LFP cathode can be approximately 1 mol Li to 1 mol Fe to 1 mol P.

In some examples of the processes described herein, the pregnant leach solution may form a first intermediary solution that is the input to a suitable separation process in which at least the iron and phosphate is separated from the first intermediary solution to create an output material that includes a relatively high concentration of lithium sulfate (Li₂SO₄), but is preferably substantially free from iron and phosphorous. The output material may be a solution and/or slurry, or may be further treated to be provided in other suitable or desirable forms.

In other examples, one or more additional processes may be performed on the PLS before it reaches the iron and/or phosphorous separation process. For example, copper and/or other materials may be precipitated from the PLS to provide a depleted solution, for example, a copper-depleted solution before it reaches the iron and/or phosphorous separation process. In such examples, the first intermediary solution that is to be subjected to the iron and/or phosphorous separation process—such as processes 108A and 108B) will include the depleted solution rather than the PLS. For the purposes of the discussion herein, the first intermediary solution is used to describe the solution that enters the iron and/or phosphorous separation process (108A, 108B or other suitable examples) that is downstream from the leaching processes (106A, 106B or other suitable examples), which may be the PLS or a further processed solution. The first intermediary solution may be in a solution/slurry form for substantially the entire processing time, or alternatively the PLS or treated solution may be partially dried, stored or processed and can then be reconstituted or reconditioned at a later time to provide a first intermediary solution having the properties that are suitable for treating using the iron and/or phosphorous separation processes.

This iron and/or phosphorous separation process may include a precipitation process and may include a single precipitation step or two or more precipitation steps. One example of a suitable separation process includes the co-precipitation of phosphorous and iron from the first intermediary solution using lime (CA(OH)₂). Another example of a suitable separation includes the co-precipitation of phosphorous and iron from the first intermediary solution using sodium hydroxide (NaOH). The specific composition of the output material, in addition to containing lithium sulfate, may vary based on the nature of the separation process used.

The output material may be used in this form, or may be subjected to additional post-processing. For example, the output material can be further processed to extract lithium metal from the solution rich in lithium sulfate using any suitable post-processing treatment technique.

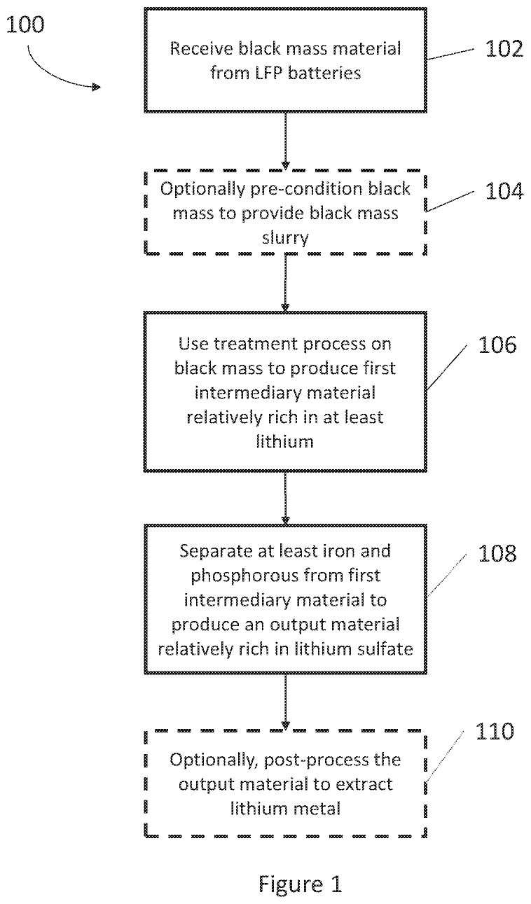

Referring to FIG. 1, one example of a method 100 of processing black mass material, including black mass obtained from LFP batteries, includes, a step 102, receiving incoming black mass material. The black mass material may be created/produced using any suitable technique and may be received in the form of a filtered product with at least some degree of residual moisture that is the output of upstream battery shredding/processing operations.

If the black mass material is derived from LFP batteries it may have different components, and in different concentrations than the black mass obtained from other types of batteries. For example, the black mass materials that may be treated using the methods described herein may include at least 1.5%, 2%, 2.5%, 3%, 3.5%, 4%, 4.5%, 5%/wt lithium, and will likely have less than about 10%/wt lithium in most examples. In some examples black mass may preferably have about 3% wt lithium. Similarly, the black mass may include at least 10%/wt iron, optionally may have less than 70%/wt iron, and preferably may have about 18% wt iron. The black mass may include between about 5% and about 40%/wt phosphorous, and optionally may have less than about 40% wt phosphorous, and preferably may have less about 10% wt phosphorous.

Optionally, for example if the black mass material is received in the manner described above, the black mass material may be pre-conditioned so that it is in a more desirable state/condition for the later steps in method 100. As shown using optional step 104, this may include adding a suitable solvent to produce a black mass slurry that has a pre-determined pulp density. In the examples described herein the pre-determined pulp density for the black mass slurry may be between about 15 wt % and about 35 wt %, and preferably may be between about 20 wt % and about 30 wt %. This may be achieved using any suitable organic solvent, such as water and/or may contain some residual solvent from electrolytes present in the batteries. In other examples the black mass material may be received as a slurry and the steps to re-slurry the material may be omitted.

With the black mass material in its desired state, which is a flowable, black mass slurry for the method 100, step 106 can then include treating the black mass slurry using a suitable process to produce a first intermediary solution having a pre-determined, and relatively rich concentration of at least lithium. The treatment process in step 106 may include a leaching process. The black mass slurry can then be leached in step 122 using sulfuric acid and other suitable reagents as appropriate, including, for example, hydrogen peroxide, oxygen and a combination thereof.

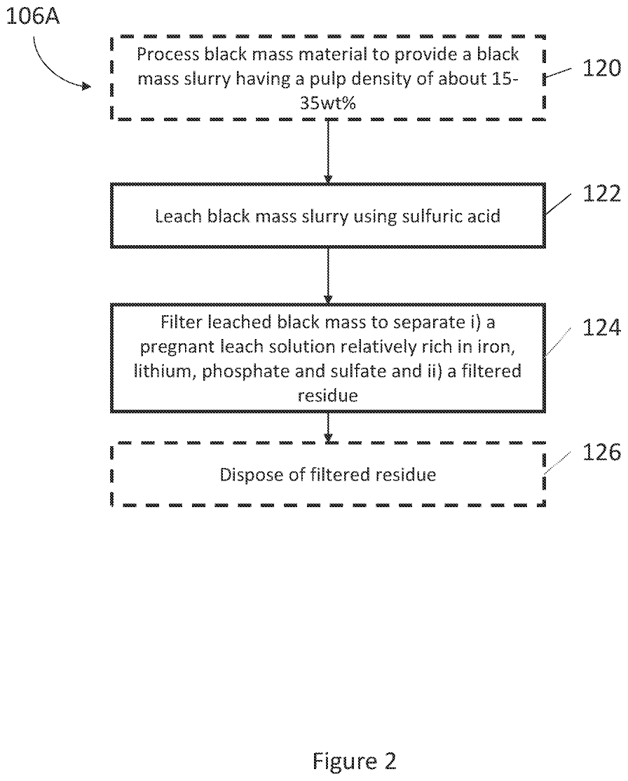

Referring to FIG. 2, one example of a suitable leaching process 106A begins with the optional step 120 of pre-conditioning or pre-processing the black mass material so that it is in a desired slurry, having the desired pulp density. This step 120 may be part of the optional step 104 or may be a separate process.

The example of the process 106A is described herein as a complete leaching process, in which the leaching step 122 includes adding sulfuric acid so that the leaching solution without the addition of an oxidant during the leaching process. The acid consumption in the complete leaching processes described herein may be relatively higher than that in the selective leaching processes. That is, the complete and selective leaching processes may also utilize different levels of acid consumption, with the complete leaching processes using more acid per kilogram of incoming feed material than the selective leaching process, which may cause the complete leaching processes to have a lower pH than the selective leaching process. In some tested examples of the leaching processes, the complete leaching process may utilize between about 0.5 and 0.75 kg of acid per kg of feed material, and optionally may utilize between 0.6 and 0.65 kg of acid per kg of feed material, whereas the selective leaching process may utilize less than 0.5 kg of acid per kg of feed material, and optionally may be configured to use between 0.4 and 0.45 kg of acid per kg of feed material.

In this complete leaching example, the solution is preferably configured so that it has a target pH of between about 0.5 and about 2.0, and may be between 1.0 and 1.75 and optionally can be about 1.5. The solution may have any suitable initial free acid concentration, and in some examples the initial free acid concentration may be between about 30 and about 60 g/L (and preferably about 40 g/L).

The solution can be held in a suitable leaching vessel for a leaching period or residence time that can be between about 2 hours and about 6 hours, and in some examples may be about 4 hours.

The complete leaching process 106A can be conducted at a desired leaching temperature that may be between about 20 and about 105 degrees Celsius. In some examples the leaching temperature may between 50 and 70 degrees Celsius and may be about 60 degrees Celsius.

At the conclusion of the leaching step 122 the resulting slurry can be filtered to separate the unwanted residues and solids, which may include at least a portion of any graphite that was in the LFP black mass material, anode and/or cathode binder (PVDF), residual solid LFP cathode and the like, and produce a pregnant leach solution.

Using the complete leaching process 106A, the resulting pregnant leach solution may be relatively rich in lithium and may also contain relatively significant concentrations of iron, phosphorous and a leach by-product, which if the process 106A is conducted using sulfuric acid may be sulfate. Optionally, the process 106A can include the step 126 of disposing of any unwanted filter residue.

For example, as explained in the first test example below, tests of the described methods that were conducted using the complete leaching process under various operating conditions have demonstrated that i) the lithium leach efficiency (e.g. amount of lithium contained in the pregnant leach stream/amount of lithium in the incoming LFP black mass material) can be greater than 92%, and may be greater than 97% and in some examples may be between about 92% and about 98%, ii) the iron leach efficiency can be greater than about 95% and may be between about 95% and about 99%, and iii) the phosphorous leach efficiency can be greater than about 95%, and may be between about 95% and about 99%, depending on the specific operating parameters chosen.

Alternatively, instead of the complete leaching process 106A, the method 100 may utilize what is described herein as a selective leaching process in which a suitable oxidant, such as air, hydrogen peroxide or the like is added during the leaching process. This process may produce a pregnant leach solution that has an acceptable concentration of lithium, but has lower amounts of iron, phosphorous and sulfate (or other leach by-product) than the PLS created using the complete leaching process 106A. This may help facilitate the subsequent processing of the PLS in the later steps of method 100 as it may require smaller amounts of other chemicals and reagents to remove and/or neutralize the relatively lower amounts of iron, phosphorous and sulfate in the post-leaching 106B PLS. This may be preferable in some examples of the described methods, even if a relatively higher amount of the target lithium metal is extracted from the slurry during the leaching process (e.g. the lithium leach efficiency is lower than that of the complete leaching process).

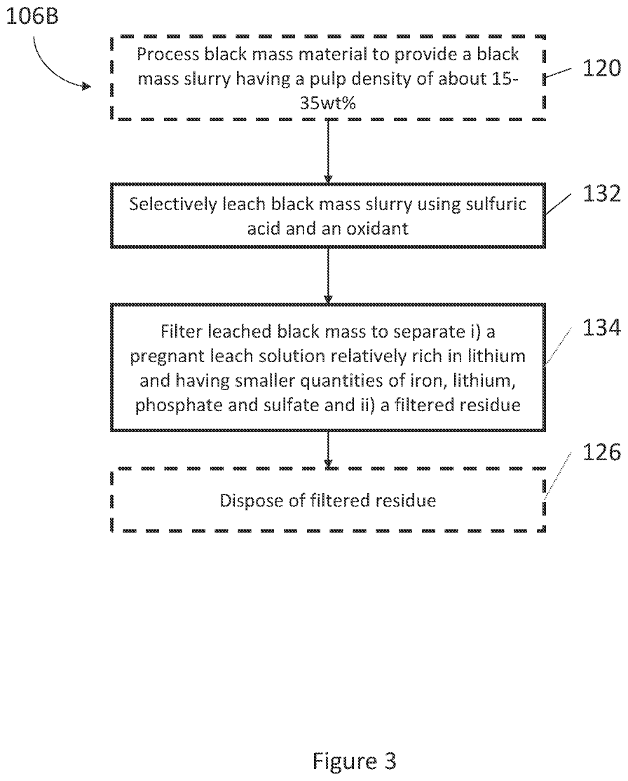

Referring to FIG. 3, an example of a selective leaching process 106B is illustrated. Like process 106A, this process 106B can include the same optional pre-treatment and disposal steps 120 and 126 described above. The process 106B also includes a leaching step 132 that is conducted under different operating conditions than step 122.

In this example, the leaching step 132 includes adding sulfuric acid and other suitable reagents as appropriate, including, for example, hydrogen peroxide, air, oxygen and a combination thereof. This process is configured so that the leaching solution has a target pH of between about 0 and about 4, and optionally can be configured so that the pH is between 0.5 and 3, or between 1 and 2.5, and may be about 2 in some examples.

The solution can be held in a suitable leaching vessel for a leaching period or residence time that can be between about 2 hours and about 6 hours, and in some examples may be about 4 hours.

The selective leaching process 106B can be conducted at a desired leaching temperature that may be between about 20 and about 100 degrees Celsius. In some examples the leaching temperature may between 50 and 70 degrees Celsius and may be about 60 degrees Celsius.

At the conclusion of the leaching step the resulting slurry can be filtered to separate the unwanted residues and solids, which may include at least a portion of any graphite that was in the LFP black mass material, anode and/or cathode binder (PVDF), residual solid LFP cathode and the like, and produce a pregnant leach solution.

At the conclusion of step 132 a pregnant leaching solution may be produced at step 134 that still retains at least 75% of the lithium from the incoming LFP black mass, and preferably can contain at least 80%, or 85% or at least 87% of the incoming lithium, but that includes relatively smaller quantities/amounts of iron, phosphorous and sulfate than the pregnant leach solution produced via the complete leaching process 106A.

For example, as explained in the second test example below, tests of the described methods that were conducted using the selective leaching process under various operating conditions have demonstrated that i) the lithium leach efficiency (e.g. amount of lithium contained in the pregnant leach stream/amount of lithium in the incoming LFP black mass material) can be greater than about 82%, may be between about 82% and about 89% in some examples, and can be about 87% under certain conditions, ii) the iron leach efficiency may be less than about 25%, and may be between about 25% and about 8%, and iii) the phosphorous leach efficiency can be less than 5%, and may be less than about 1% and/or between about 5% and about 0% in some examples.

While sulfuric acid is described in the present examples, the leaching processes may, in other examples use other acids, such as hydrochloric, nitric, phosphoric, citric, hydrofluoric, and acetic acids or the like, in which case the leach by-product that is included in the pregnant leach solution may be something other than sulfate.

Referring again to FIG. 1, having completed the desired treatment process (e.g. leaching process 106A or 106B for example) and producing the first intermediary solution in the form of the pregnant leach solution that is obtained from the leaching steps, the method 100 then continues to step 108 in which a separation process is used to separate at least some of, and preferably substantially all (e.g. preferably more than 90%) of, the iron and the phosphorous from the first intermediary solution to produce an output material, likely a slurry or solution, that is relatively richer in lithium sulfate than the first intermediary solution was and is substantially free from iron and phosphorous. In the examples described herein, the first intermediary solution that is created after the leaching process, and after other optional, intervening processing steps, may be at a generally acidic pH that is less than 4 and may between about 1 and 3, or between about 1.5 and 2.

The iron and phosphorous separation process at this stage may include a precipitation process that is conducted within a suitable precipitation reactor. The precipitation reactor used may include a single precipitation vessel, or optionally may include two or more precipitation vessels to accommodate performing two or more precipitation steps in series, or other suitable configuration.

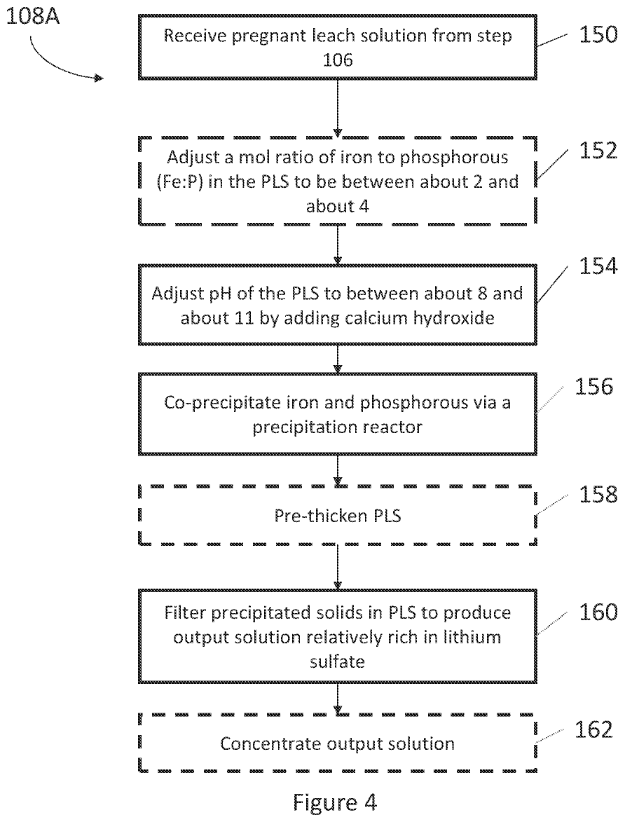

Referring to FIG. 4, one example of a suitable precipitation process 108A includes, at step 150 receiving the intermediary material from step 106, which in the described examples will include the pregnant leach solution (such as the completely leach PLS from process 106A or the selectively leached PLS from process 106B). The iron and phosphorous separation processes (such as methods 108A and 108B) are preferably configured to help extract as much iron and phosphorous from the PLS/intermediary material as practical while leaving as much lithium (possibly in the form of lithium sulphate) behind in the resulting output solution as can be practically achieved using the steps described herein.

In one example, having received the incoming PLS stream, the process 108A then includes the step of preparing the PLS for a precipitation-based separation process by, for example, adjusting its pH, and/or adjusting the concentration of iron and phosphorous within the PLS stream to be in a desired, pre-determined ratio and other such factors.

In the present example this includes an optional step 152 that includes adjusting the composition of the PLS so that a mol ratio of iron to phosphorous (Fe:P) in the solution is between about 1 and about 4, and preferably is between about 2 and about 3 and most preferably is about 2, but other concentrations may be possible.

One method of obtaining the desired Fe:P ratio can include adding an iron-containing reagent into the PLS stream to help increase the amount of iron present and shift the ratio as desired. Suitable iron-containing reagents include ferrous sulfate, ferric sulfate, ferric chloride and ferrous metal.

Alternatively, or in addition, a possible source of iron in the process could be the introduction of iron containing materials (possibly scrap iron or the like) into the leaching vessels used in step 106A, if the leaching process used is a complete leaching process using sulfuric acid. This method could introduce iron into the black mass material during the leaching process, and if sufficient iron were added this may reduce and/or eliminate the need to add a separate, iron-containing reagent during step 108. As shown in more detail herein, testing has determined that adjusting the molar ratio of Fe:P in this manner may affect the phosphorus precipitation efficiency of this step 108A/B, as tests in which step 152 was omitted (e.g. no intentional adjustment of the Fe:P molar ratio was done) the phosphorous precipitation efficiency was around 95% whereas tests in which step 152 was included produced a higher phosphorous precipitation efficiency, or about 98%.

Whether or not the mol balancing in step 152 is preformed, the process 108A can then advance to step 154 in which the pH of the solution is adjusted to be within a pre-determined, target precipitation range, which is preferably alkali/basic and can be between about 8 and about 11, and preferably between about 9 and about 10.5. In some examples, the target pH may be about 10.2 or 0.5. Optionally, a similar pH adjusting step can also be conducted prior to step 152 if appropriate.

Adjusting the pH may be done using a variety of different methods and, in process 108A is achieved by introducing lime (CA(OH)₂) into the product stream. The introduction of the Fe₂SO₄ as part of the phosphate separation process may change the pH of the material being processed. If the pH is changed to be outside the desired pH range then pH may be re-adjusted using a suitable technique. Optionally, if the pH is outside the desired pH range then additional lime (CA(OH)₂) can be added into the product stream to readjust the pH to the target range of about 8-11, or between about 9-10.

With the pH in the desired range process 108A can proceed to step 156 in which iron and phosphorous are precipitated out of the PLS/intermediary material. Preferably, step 156 includes co-precipitation of the iron and phosphorous.

Optionally, the precipitation in step 156 can be assisted by the addition of a suitable flocculant into the process stream. For example, to help facilitate the desired separation this step may include introducing a flocculant into the input material and precipitating ferrous phosphate out of solution. Any suitable flocculant may be used, such as C—(N—COCO-1, 3 diaminopropane acetate) as an example. The concentration of the flocculant can be set so to any effective concentration, and optionally the flocculant may have a concentration of between about 10 ppm and about 30 ppm, and preferably may have a concentration of about 20 ppm within the input material slurry. The separation process may also optionally include filtering the input material to remove solid ferrous phosphate particle. One example of a suitable flocculant is Duomac™.

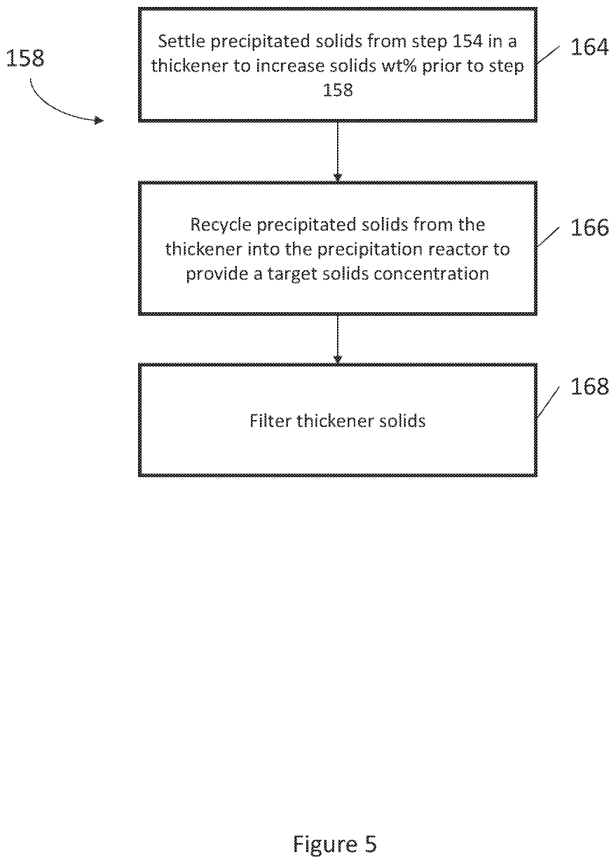

Optionally, the process 108A can include pre-thickening the PLS prior to step 160 to help facilitate precipitation of the iron and phosphorous, as shown via optional step 158. Referring also to FIG. 5, if this step is performed it can include, at step 164, settling at least some of the precipitated solids from step 154 into a suitable thickener, such as a CCD circuit. This can be done to increase the solids wt % within the PLS to a desired treatment range that can be between about 15 and about 40 wt %, and preferably may be between about 25 and about 35 wt %.

The precipitation process 108A can be conducted at a desired precipitation temperature that can be between about 5 and about 80 degrees Celsius, and may be between 10 and 50 degrees Celsius or between 15 and 30 degrees Celsius, and may be about 20 degrees Celsius.

The precipitation process can be performed for a precipitation period that or residence time that can be between about 0.5 hours and about 4 hours, and in some examples may be about 2 hours.

At step 166 at least some of the precipitate solids from step 164 can be recycled upstream and the process 108A and can be added into the precipitation reactor to help seed the desired precipitation reactor. Optionally, this recycling can help provide a target solids concentration within the precipitation reactor that can be between about 10 and about 25 g/L. This may help reduce the amount of lime that is consumed during the process 108A. This can include filtering at least some of the thickeners solids, and possibly some of the overflow water or other solvent used in step 158, as shown in step 168. The filtration in step 168 may be part of the overall filtration process in step 160 or may be a separate operation.

Referring again to FIG. 4, the process 108A can then include the step of filtering the precipitated solids out of the PLS (having been pre-thickened or not) using a suitable filter apparatus at step 160. The permeate passing through the filter can form a desired output solution that is relatively richer in lithium sulfate than the intermediary material/PLS was before performing step 108.

When steps 156-160 are complete (e.g. the solid precipitates have been filtered out of the solution) the remaining process material will be a solution that is relatively rich in Li₂SO₄. Testing of these processes revealed that the iron precipitation efficiency can be greater than 99%, and may be about 99.9% whether optional step 152 is conducted or not.

Optionally, the process 108A can be configured so that the concentration of Li₂SO₄ in the post-precipitation solution is above a target threshold, which may be greater than 7 wt % U. This may provide the output solution from the process 108A. Alternatively, it may be desirable in some embodiments of this method 100 and process 108A (or 108B) to further concentrate the output solution obtained after step 160 to further increase its relative concentration of Li₂SO₄ before it is sent for further processing and/or lithium recovery. If this is desired, the method 108A can include the optional step 162 that includes processing first output solution to provide a second or concentrated output solution having a second concentration of Li₂SO₄ that is greater than the concentration of Li₂SO₄ at the completion of step 160. Preferably, the second concentration is at least 50% greater than the concentration of Li₂SO₄ at the completion of step 160.

This concentrating can be done using any suitable techniques, including evaporating at least a portion of the organic solvent from the first intermediary solution, optionally by boiling the first intermediary solution. For example, an MVR (mechanical vapour recompression process) or other suitable boiler may be used to extract liquid from the solution, thereby increasing the relative concentration of Li₂SO₄ to a desired level that can help facilitate further processing.

The Li₂SO₄ product solution, whether optionally concentrated in step 162 or not, can then be sent for further processing and/or processed to help extract the target lithium material. That is, the output solution at the conclusion of process 108A can be considered an end product of method 100 or optionally, as shown using optional step 110 in FIG. 1, the method 100 may include a suitable post-processing step in which the output solution from step 108 is further treated to produce further output products. The output products may include, for example, lithium metal. For example, the Li₂SO₄ solution could be reacted with a suitable amount of sodium carbonate to produce lithium carbonate.

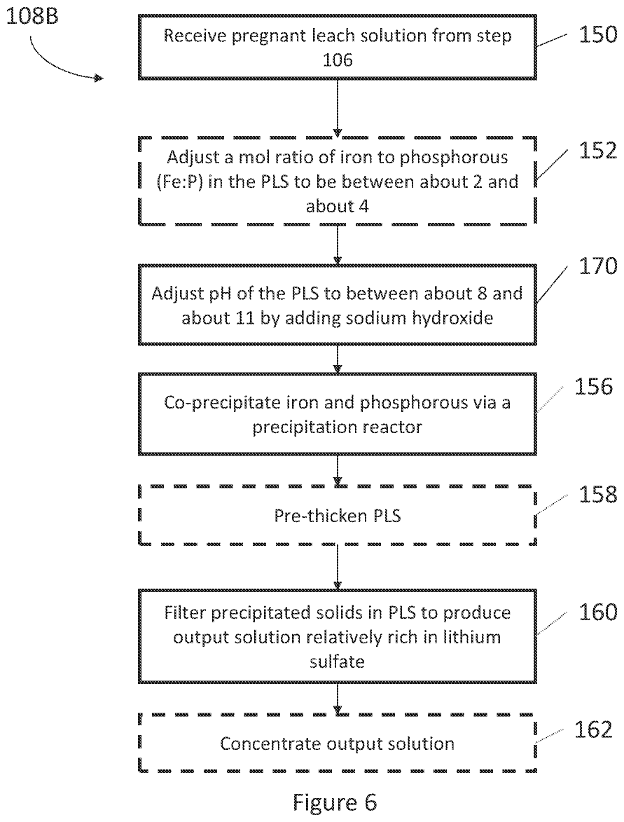

Referring to FIG. 6, an alternative example of a suitable precipitation process 108B includes the steps 150, 152, 156, 158 and 106 as described with respect to method 108A. However, instead of step 154, the method 108B includes, at step 170, adjusting the pH of the PLS by adding a reagent that is or contains sodium hydroxide rather than using lime as was used in method 108A. Using sodium hydroxide in this step may reduce and/or eliminate the introduction of calcium into the method 100. Limiting the amount of calcium present may help reduce and/or may eliminate the generation of calcium sulfate when the method 100 is performed. This may be desirable as calcium sulfate can be considered a waste by-product of the method 100, and reducing its generation may help improve the efficiency of the method 100 and/or reduce the amount of waste generated.

One output of these phosphate separation processes 108A and 108B, in addition to the output solution that is ready for further processing and/or lithium extraction, can be a quantity of iron phosphate material, which may be useful as a fertilizer or may have other agricultural and/or industrial uses. Configuring the process to create useful by-products of this nature may help reduce the amount of waste that is produced as part of the battery recycling process.

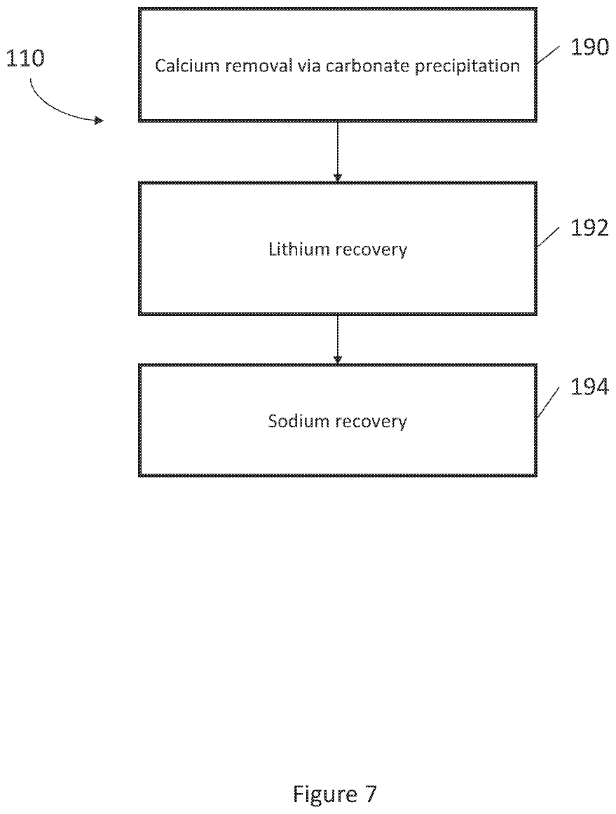

Optionally, the output solution that is obtained after the iron and phosphorous precipitation step can be processed to remove additional impurities and to recover at least the target lithium materials. Referring to FIG. 7, one example of some subsequent processing processes in optional step 110 can include an additional precipitation process at step 190 to remove calcium from the output material to produce a calcium depleted material stream. This can be done using any suitable process, including a precipitation process in which sodium carbonate is introduced into the output material as a precipitating agent, preferably at a ratio of about 1.25× stoichiometric of calcium in the output material (but other ratios may also be used). This process can be conducted at a suitable pH, such as pH of between about 9-11, and may be about 10 in some examples, at a temperature of between about 5 and 80 degrees Celsius (preferably about 20 degrees) and with residence time of between about 0.5 and 4 hours (preferably about 2 hours), as appropriate. Testing has determined that this process can provide a calcium precipitation efficiency of about 99%.

Optional step 192 includes the recovery of lithium from the calcium-depleted product stream, also via a carbonate precipitation process similar to that described in step 190, in which lithium carbonate is precipitated out of the calcium-depleted product stream thereby providing a lithium-depleted stream.

Optionally, the lithium-depleted stream can be further processed, at step 194, to recover sodium via an anhydrous sodium recovery process. For example, step 194 may optionally include a process for crystallizing sodium sulfate in which a filtrate exiting step 192 reports to an evaporative crystallizer to produce sodium sulfate decahydrate/Na₂SO₄.10H₂O. In some embodiments, sulfuric acid is added during crystallization to convert residual carbonate (e.g. Na₂CO₃ (aq)) into a sulfate form. In some embodiments, the resulting crystallized slurry reports to solid-liquid separation; and, separated solid product reports to a drier, wherein the drier drives off water and produces anhydrous sodium sulfate/Na₂SO₄. In some embodiments, solid-liquid separation can be achieved using a centrifuge. While shown in one particular order herein, steps 190, 192 and 194 need not be done only in this order and may be performed in a different order in some examples of the process 100 or 500.

Further examples of suitable post-iron/phosphorous removal processes ion step 110 can be found in international patent publication no. WO2018/218358 entitled A Process, Apparatus, And System For Recovering Materials From Batteries, which is incorporated herein by reference.

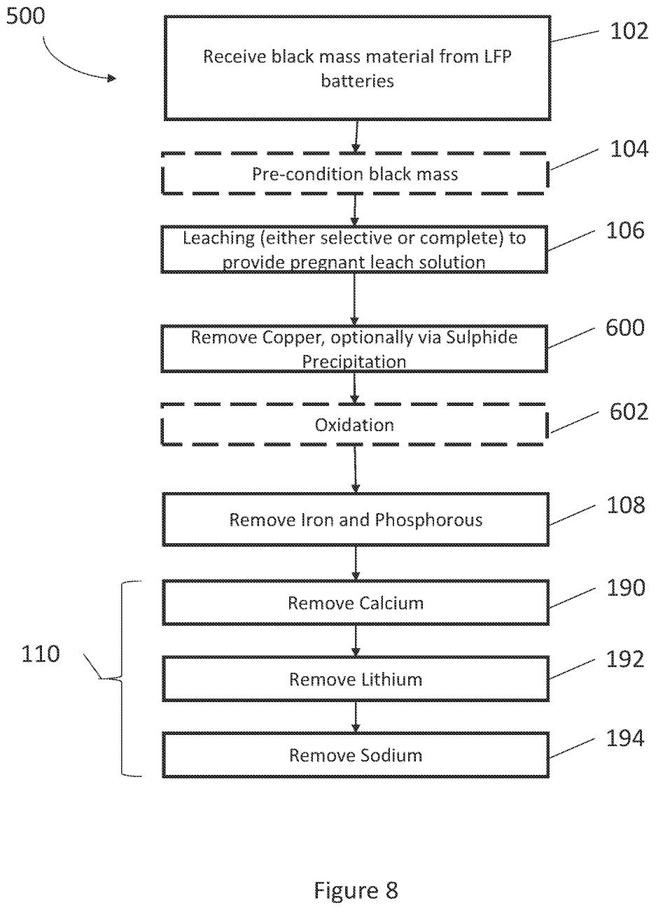

Referring to FIG. 8, another example of a process/method 500 for processing black mass liberated from LFP batteries material is illustrated, and includes steps 102, 104, 106, 108 and 110 as generally described herein. The black mass obtained from batteries, including lithium-ion batteries and LFP batteries may include copper, and/or other compounds that remain in the post-leaching filtrate stream at the conclusion of step 106.

Therefore, the method 500 may also include an optional, additional step 600 in which the filtrate from the leaching process 106 is treated to help remove at least some of other compounds/material from the post-leaching filtrate, including copper, before the PLS reaches the iron and phosphorous removal processes at step 108. That is, the method 500 can optionally include processing the PLS to remove all or at least substantially all of the copper from the solution to produce a copper-depleted PLS. The first intermediary solution that enters step 108 can then include the copper-depleted PLS.

The copper removal processes used for step 600 can be any suitable process that can remove copper from the PLS and that is compatible with the operating conditions and other components of the PLS as described herein. This may include, for example, a precipitation process (such as a sulphide precipitation process), a solvent extraction process, a copper cementing process or the like.

For example, the inventors have discovered that at least some of these materials, including metals, such as copper, may be separated from the PLS/filtrate solution via a copper ion exchange or copper solvent extraction process, such as the copper solvent extraction process that is used extracting copper from a pregnant leach solution containing battery black mass material, as described in international patent publication no. WO2018/218358 entitled A Process, Apparatus, And System For Recovering Materials From Batteries (which is incorporated herein by reference).

Optionally, the copper separation process at step 600 could include a cementation process, such as the cementation of copper in which copper ions in the PLS are precipitated out of solution in the presence of a suitable metal, such as iron, in accordance with the following exemplary reaction:

Cu2+(aq)+Fe(s)→Cu(s)+Fe2+(aq)

Using iron as the reagent may be desired in the examples described herein, as the PLS will include at least some of the iron from the LFP black mass. Other reagents and cementing processes may be used if desired.

Further, the inventors have also discovered that at least some of these materials in the PLS, including metals, such as copper, may be separated from the PLS/filtrate solution via a sulphide precipitation process, instead of the solvent extraction process or cementing process. For example, the inventors have developed a process by which a sulfide, such as sodium hydrosulphide (NaHS) or sodium sulfide (Na₂S), hydrogen sulphide (H₂S) (amongst others) could be used to help precipitate a variety of metal-sulfides in accordance with the following, exemplary, reactions:

Cu(SO₄)+Na₂S=CuS+Na₂(SO₄)

Utilizing a sulfide precipitation process may help reduce the complexity and/or capital and operating costs of the process 500, as compared to using a comparable solvent extraction process.

If a sulphide precipitation process is used at step 600 it can be conducted in any suitable precipitation vessel that has suitable containment and ventilation systems, and under suitable residence times and operating conditions. Based on bench-scale testing that has been conducted by the Applicant, it is believe that the sulfide precipitation processes at step 600 may be conducted with a residence time of between about 0.5 and about 4 hours, and may be about 2 hours, and at an operating temperature that is between approximately 5 and 80 degrees Celsius, and may be conducted at about 20 degrees Celsius. The pH of the solution at step 600 can be adjusted to be between approximately 0-4, and may, in some examples, be adjusted to be about 1.5.

This precipitation process can be conducted such that the oxidation reduction potential (ORP) of the filtrate solution that is produced at the end of the process (which may also be referred to as the copper-depleted PLS which forms the first material solution in some of the present examples) may be at a precipitation ORP target range that is between about −200 mV and about 0 mV, and in some examples may be greater than about −100 mV and may be approximately −50 mV.

The amount of the sulfide reductant that is used in process 600 can be selected based on a variety of suitable factors/criteria. For example, for examples in which the reagents include sodium hydrosulphide (Na₂S) and/or sodium hydrosulphide (NaHS), the process can be configured such that the sulphide concentration in the solution is between about 5-20% and/or so that excess sulfide is provided, such as between about 1.2-1.6×, and optionally between about 1.4-1.5× or between about 1.41-1.44×, the stoichiometric concentration of the target metals (such as copper, etc.) in the pregnant leach solution.

When the precipitation process is complete, or at least substantially complete (e.g. at the end of the prescribed residence time) the slurry can be solid/liquid separated using any suitable separation apparatus, such as a filter. The filter cake containing the residue can be extracted for further processing, sale or disposal, etc. and the post-sulphide precipitation filtrate can be sent for further downstream processing.

Testing of this process 600 indicates that a copper precipitation efficiency of over 99%, and in some conditions about 99.9% can be achieved using these methods.

Optionally, in some examples, this post-sulphide precipitation filtrate can progress directly to step 108 without being subjected to any further, substantial processing. Alternatively, in some examples, the methods described herein can include the optional step 602 in which the oxidation reduction potential of the filtrate is adjusted to a desired range prior to advancing to step 108. This can, in some examples, include introducing a suitable oxidant (such as hydrogen peroxide, oxygen and the like) into the filtrate leaving step 600 until the ORP of the filtrate reaches a target ORP value, that can be equal to or above 300 mV, equal to or above 400 mV, equal to or above 450 mV and equal to or above 500 mV.

Testing was conducted in accordance with at least some of the embodiments described herein and has demonstrated that the processes and operating ranges descried herein can provide useful results. A brief description of some exemplary, representative tests is included below.

A first test example of the described treatment processes was performed to validate a first example of processes described herein.

Lithium iron phosphate (LFP) black mass in generated using a suitable size reduction process on LFP batteries. This LFP black mass obtained for this test included approximately 2.1 wt % lithium (Li), 15.3 wt % iron (Fe) and 7.8 wt % phosphorus (P). A complete leaching was conducted (generally in accordance with process 106A as described herein) with a pulp density of 20 wt % in sulfuric acid (H₂SO₄) for residence time of 4 hours and at and operating temperature of approximately 60° C. The leach solution was maintained at a pH of 1.5 via addition of H₂SO₄ over the course of the reaction/residence time.

The pregnant leach solution (PLS) was then separated from the residue using a Buchner funnel with a Whatman® grade 3 filter paper attached to a vacuum flask. Analysis of this solution revealed a leaching efficiency of approximately 97.1% for Li, 99.3% for Fe and 98.9% for P with concentrations of 3.9 g/L, 30.0 g/L and 18.3 g/L respectively in the PLS.

The PLS then proceeded to the Fe and P removal stage (e.g. step 108 herein) where the molar ratio of Fe:P was adjusted to 2:1 via the addition of ferrous sulphate (FeSO₄), which resulted in the addition of 97.7 g FeSO₄ per liter of PLS. Precipitation was conducted by the addition of calcium hydroxide (Ca(OH)₂) via a slurry containing 20 wt % Ca(OH)₂ and adjusting the PLS to pH 10.5 at 20° C. (for example, as in accordance with process 108A when also including optional step 152). The solution was separated from the precipitate using a Buchner funnel with a Whatman® grade 3 filter paper attached to a vacuum flask. The filtered solids are then washed in warm (50° C.) water and filtered a second time using the same procedure as previously stated. Testing of the outputs of this process revealed approximately 99.9% of Fe and approximately 98% of P deported to solids. The filtrate generated from this process is a Li rich bearing solution which can proceed to typical Li recovery processes (such as those described in relation to step 110 herein).

A second test example of the described treatment processes was performed to validate a second example/application of the processes described herein. In this second test Lithium iron phosphate (LFP) black mass in generated using a size reduction process on LFP batteries. The black mass used in this example had a composition of approximately 2.1 wt % lithium (Li), 15.3 wt % iron (Fe) and 7.8 wt % phosphorus (P). A selective leaching process (such as in accordance with process 106B herein) was conducted with a pulp density of 20 wt % in sulfuric acid (H₂SO₄) for a residence time of approximately 4 hours at an operating temperature of approximately 60° C. The leach solution in this test was maintained at a pH of 2.0 via addition of H₂SO₄ over the course of the reaction/residence time. Additionally, an oxidant, in this case oxygen gas (O₂), was sparged into the leach at a rate of 1.5 L/min over the course of the leaching process.

The resulting pregnant leach solution (PLS) was separated from the residue using a Buchner funnel with a Whatman® grade 3 filter paper attached to a vacuum flask. Testing of the outputs of this process revealed a leaching efficiency of approximately 87.7% for Li, 22.9% for Fe, 0.9% for P and 94.9% for Cu with concentrations of 3.4 g/L, 3.8 g/L, 0.2 g/L and 6.2 g/L respectively in the PLS.

The PLS then proceeded to the Cu removal stage where a reductant, in this case sodium hydrosulphide (NaHS) as a 20 wt % NaHS solution, is added to precipitate Cu as a sulphide (in accordance with step 600 herein). The NaHS was added to help reduce the oxidation-reduction potential (ORP) of the PLS to about −50 mV at 20° C. The solution was separated from the precipitate using a Buchner funnel with a Whatman® grade 3 filter paper attached to a vacuum flask. In this process 99.9% of Cu deported to solids.

The filtrate following this step then proceeded to the Fe and P removal stage (such as step 108). Precipitation was conducted by the addition of calcium hydroxide (Ca(OH)₂) via a slurry containing 20 wt % Ca(OH)₂ and adjusting the PLS to pH 10.5 at 20° C. (e.g. in accordance with step 108A but without optional step 152). The solution was separated from the precipitate using a Buchner funnel with a Whatman® grade 3 filter paper attached to a vacuum flask. The filtered solids are then washed in warm (50° C.) water and filtered a second time using the same procedure as previously stated. In this process about 99.9% of Fe and 95% of P deported to solids. The filtrate generated from this process is a Li rich bearing solution which can proceed to typical Li recovery processes (such as step 110).

The relatively lithium rich solutions that are obtained after the iron and phosphorous separation as described in the above examples (for example using processes 108A or 108B) was then used as the input stream for additional testing. In a third exemplary test example, the such a Li rich solution, which could be produced in a manner similar to Examples 1 and 2, was processed and calcium (Ca) removal was completed on a solution which contained 0.4 g/L Ca. Precipitation was conducted, in this example, by the addition of sodium carbonate (Na₂CO₃) via a solution containing 20 wt % Na₂CO₃ to the Li rich solution. The Na₂CO₃ solution was added to the filtrate such that the carbonate (CO₃²⁻) was 1.25 times the stoichiometric requirement to precipitate the Ca. The solution was separated from the precipitate using a Buchner funnel with a Whatman® grade 3 filter paper attached to a vacuum flask. The filtered solids are then washed in water and filtered a second time using the same procedure as previously stated. In this process 99% of Ca deported to solids.

The Li rich solution was evaporated to reduce the volume to a point when the Li concentration reached a concentration of 11 g/L. A saturated Na₂CO₃ solution was prepared with as concentration of 430 g/L and heated to 90° C. The Na₂CO₃ solution was added to the filtrate such that the carbonate (CO₃²⁻) was 1.25 times the stoichiometric requirement to precipitate the Li. The mixture of the evaporated solution and Na₂CO₃ solution was mixed at 95° C. for 2 hours. The solution was separated from the precipitate using a Buchner funnel with a Whatman® grade 3 filter paper attached to a vacuum flask. The filtered solids were then washed in hot (90° C.) water and filtered a second time using the same procedure as previously stated. In this exemplary process 81.2% of Li deported to solids.

For the purposes of describing operating ranges and other such parameters herein the phrase “about” or “approximately” means a difference from the stated values or ranges that does not make a material difference in the operation of the systems and processes described herein, including differences that would be understood a person of skill in the relevant art as not having a material impact on the present teachings. For pressures and temperatures about may, in some examples, mean plus or minus 10% of the stated value but is not limited to exactly 10% or less in all situations. For example, a pH of about 2 may be understood to include a pH between 1.8 and 2.2. Similarly, “substantially all” can be understood to mean practically and/or materially all of the substance has been removed from the solution, and may mean separation efficiencies of at least 90%, or higher in some instance as would be understood by a person skilled in the art.

All publications, patents, and patent applications referred to herein are incorporated by reference in their entirety to the same extent as if each individual publication, patent, or patent application was specifically and individually indicated to be incorporated by reference in its entirety. It is understood that the teachings of the present application are exemplary embodiments and that other embodiments may vary from those described. Such variations are not to be regarded as a departure from the spirit and scope of the teachings and may be included within the scope of the following claims.

What is claimed is:

1. A method of processing a black mass material feed material comprising materials liberated from within lithium iron phosphate (LFP) battery materials, the method comprising:
a) receiving a black mass feed material comprising iron, phosphorous, graphite and lithium derived from LFP batteries and having a first concentration of lithium;
b) acid leaching the black mass material at a pH that is less than 4, thereby producing a pregnant leach solution (PLS) comprising less graphite than the black mass feed material, at least 80% the lithium from the black mass feed material, and at least a portion of the iron and the phosphorous from the black mass feed material, the PLS having a second concentration of lithium that is greater than the first concentration of lithium;
c) providing a first intermediary solution after completing step b); and
d) separating at least 90% of the iron and the phosphorous from the first intermediary solution to provide an output solution having less iron and phosphate than the first intermediary solution and having a third concentration of lithium that is greater than the second concentration.

2. The method of claim 1, wherein the first intermediary solution comprises the PLS.

3. The method of claim 1, wherein the PLS produced in step 1b) comprises copper and further comprising processing the PLS to remove substantially all of the copper and produce a copper-depleted PLS, whereby the first intermediary solution comprises the copper-depleted PLS.

4. The method of claim 3, wherein processing the PLS to remove substantially all of the copper comprises at least one of a copper solvent extraction process, a copper cementing process and a copper sulphide precipitation process.

5. The method of claim 4, wherein processing the PLS to remove substantially all of the copper comprises sulfide precipitation of the PLS, whereby copper sulphide is precipitated from the PLS to produce the copper-depleted PLS.

6. The method of claim 5, wherein the sulfide precipitation of the PLS comprises adding a reductant comprising at least one of sodium hydrosulphide and sodium sulphide to the PLS.

7. The method claim 6, wherein the sulfide precipitation is conducted with a residence time of between about 0.5 and about 4 hours and at an operating temperature that is between approximately 5 and 80 degrees Celsius.

8. The method of claim 7, wherein the residence time is 2 hours and the operating temperature is about 20 degrees Celsius.

9. The method of claim 5, wherein the sulfide precipitation is conducted with a solution pH that is less than 4.

10. The method of claim 9, wherein the solution pH is about 1.5.

11. The method of claim 5, wherein the sulfide precipitation produces a filtrate solution having an oxidation reduction potential (ORP) between −200 mV and 0 mV.

12. The method of claim 11, further comprising adjusting the ORP of the filtrate solution to be equal to or above 400 mV by introducing an oxidant into the filtrate solution, thereby producing the copper-depleted PLS.

13. The method of claim 5, wherein at least 99% of the copper is precipitated out of the PLS.

14. The method of any one of claims 1 to 13, wherein the separating in step 1d) comprises precipitating at least the iron and the phosphorous from the first intermediary solution via hydroxide precipitation, thereby producing the output solution.

15. The method of claim 14, further comprising adjusting a pH of the first intermediary solution to be between about 8 and 11 to promote the precipitation of the iron and the phosphorous.

16. The method of claim 14, further comprising adjusting the pH to be between 10 and 10.5.

17. The method of claim 14, wherein adjusting the pH comprises introducing at least one of calcium hydroxide and sodium hydroxide as a precipitating reagent during the hydroxide precipitation.

18. The method of claim 17, wherein adjusting the pH comprises adding Ca(OH)₂ to the first intermediary solution.

19. The method of claim 17, wherein adjusting the pH comprises adding sodium hydroxide to the first intermediary solution.

20. The method of claim 17, further comprising adjusting the first intermediary solution so that a mol ratio of iron to phosphorous (Fe:P) in the first intermediary solution is between about 1 and about 4.

21. The method of claim 20, wherein the mol ratio of iron to phosphorous (Fe:P) in the first intermediary solution is about 2.

22. The method of claim 20 or 21, wherein the mol ratio of iron to phosphorous (Fe:P) in the first intermediary solution may be adjusted by adding an iron-containing reagent into the first intermediary solution.

23. The method of any one of claims 1 to 22, wherein step 1d) further comprises introducing a flocculant into the first intermediary solution.

24. The method of claim 23, wherein the flocculant may include C—(N—COCO-1, 3 diaminopropane acetate).

25. The method of claim 23 or 24, wherein the flocculant may have a concentration of between about 10 ppm and about 30 ppm in the first intermediary solution.

26. The method of claim 14, further comprising filtering the first intermediary solution to remove solid ferrous phosphate particle and produce the output solution.

27. The method of claim 1, further comprising pre-conditioning the black mass material prior to step 1b) by adding a solvent to the black mass material to provide a flowable black mass slurry.

28. The method of claim 27, wherein the flowable black mass slurry has a pulp density of between about 15 wt % and about 35 wt %.

29. The method of any one of claims 1 to 28, wherein the acid leaching is conducted at a temperature that is between 20 and 100 degrees Celsius.

30. The method of any one of claims 1 to 29, wherein step 1b) comprises leaching the black mass material using a leaching solution comprising sulfuric acid, whereby the PLS comprises lithium, phosphate, iron and sulfate.

31. The method of claim 30, wherein the wherein the acid leaching comprises leaching the black mass using a leaching solution having a pH of between about 0.5 and about 2.0.

32. The method of claim 31, wherein the leaching solution comprises an initial free acid concentration of between about 30 g/L and about 60 g/L.

33. The method of any one of claims 1 to 32, wherein the acid leaching is conducted for a residence time that is between about 2 hours and about 6 hours.

34. The method of claim 33, wherein the concentration of lithium in the PLS is greater than the concentrations of phosphate, and iron in the PLS.

35. The method of claim 33, wherein the acid leaching is conducted for a leaching residence time that is between about 2 hours and about 6 hours, and wherein the leaching solution is at a leaching temperature that is between about 15 degrees Celsius and about 80 degrees Celsius.

36. The method of any one of claims 1 to 35, further comprising concentrating the output solution by extracting at least some solvent from the output solution to produce a concentrated output solution having a fourth concentration of lithium (wt %) that is greater than the third concentration of lithium.

37. The method of any one of claims 1 to 36, wherein the black mass material comprises at least 1.5%/wt lithium.

38. The method of claim 37, wherein the black mass material comprises less than about 10% wt lithium.

39. The method of claim 38, wherein the black mass material comprises about 3% wt lithium.

40. The method of any one of claims 1 to 39, wherein the black mass material comprises at least 10%/wt iron.

41. The method of claim 40, wherein the black mass material comprises less than 70% wt iron, and

42. The method of claim 41, wherein the black mass material comprises about 18% wt iron.

43. The method of any one of claims 1 to 42, wherein the black mass material comprises at least 5%/wt phosphorous.

44. The method of claim 43, wherein the black mass material comprises less than about 40% wt phosphorous.

45. The method of claim 43 or 44, wherein the black mass material comprises less than about 10% wt phosphorous.

46. The method of any one of claims 1 to 45, wherein the output solution comprises calcium and further comprising extracting substantially all of the calcium from the output solution to provide a calcium-depleted material stream comprising at least lithium and sodium.

47. The method of claim 46, wherein the extracting substantially all of the calcium from the output solution comprises a carbonate precipitation process via which more than 95% of the calcium is precipitated out of the output solution.

48. The method of claim 47, further comprising adding a sodium carbonate precipitating agent at a ratio of about 1.25× the stoichiometric concentration of calcium in the output solution.

49. The method of claim 46, wherein the carbonate precipitation process is conducted at a pH that is less than 11, for a residence time that is between 0.5 and 4 hours and at a temperature that is between about 5 and about 80 degrees Celsius.

50. The method of any one of claims 46-49, further comprising extracting substantially all of the lithium from the calcium-depleted material stream to provide lithium-rich residue and a lithium-depleted stream comprising the sodium.

51. The method of claim 50, wherein extracting substantially all of the lithium from the calcium-depleted material stream comprises a carbonate precipitation process in which a Na₂CO₃ solution was added to the calcium-depleted material stream at a ratio of 1.25 times the stoichiometric requirement to precipitate the lithium, whereby more than 80% of the lithium is precipitated out of the calcium-depleted material stream as the lithium-rich residue.

52. The method of any one of claims 1 to 51, further comprising prior to step 1a):
a) processing LFP battery materials in a comminuting apparatus comprising at least a first comminuting device that is submerged in an immersion liquid, thereby creating reduced-size battery materials and liberating electrolyte material and the black mass solids comprising anode and cathode powders from within the LFP battery materials and providing a sized-reduced feed stream comprising the reduced size battery materials and the black mass solids and electrolyte materials entrained within the immersion liquid; and
b) processing the size-reduced feed stream to obtain the black mass feed material that comprises the black mass solids and a retained portion of the immersion liquid having entrained electrolyte materials.

53. The method of claim 52, wherein the black mass feed material comprises less than about 20% wt of the immersion liquid having entrained electrolyte materials.

54. The method of claim 52 or 53, wherein step 52b) comprises treating the sized-reduced feed stream with a first separator that separates the sized-reduced feed stream into the black mass feed material and at least a first filtrate stream comprising a second portion of the immersion liquid having entrained electrolyte materials therein.

55. The method of claim 54, wherein the first separator comprises a liquid-solid filter and wherein the first filtrate stream passes through the liquid-solid filter and the black mass feed material comprises a filter cake material retained by the liquid-solid filter.
